(19) United States
(12) Patent Application Publication
(10) Pub. No.: US 2005/0213831 A1
(43) Pub. Date: Sep. 29, 2005

(54) Method and system for encoding fractional bitplanes

(76) Inventor: Mihaela Van Der Schaar, Martinez, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/506,342

(22) PCT Filed: Mar. 4, 2003
(86) PCT No.: PCT/IB03/00789

§ 371 Date: Sep. 1, 2004

(30) Foreign Application Priority Data
Mar. 5, 2002 (US) 6036592
Dec. 17, 2002 (US) 60434055

(51) Int. Cl. G06K 9/36

(52) U.S. Cl. 382/240

(57) ABSTRACT

In a layered encoding system having at least one layer comprising a plurality of sub-layers (272, 274, 276), a method is disclosed herein for encoding a video image (200) composed of a plurality of pixel blocks containing at least one area determined to be significant (200, 215, 220) within a corresponding sub-layer (272, 274, 276). The method comprises the steps of; associating a level of significance with each block (250, 252) of a known size within the at least one significant area (200), associating a level of significance with successively larger blocks (222, 244) dependent upon the level of significance of at least one of the blocks (250, 252) of a known size contained within said larger block (222, 244), and mapping each of the associated levels of significance. In another embodiment of the invention, the significance map is transmitted and corresponding image layers may be reconstructed using the significance map.

The present invention relates to video image encoding and more specifically to fractionally encoding enhancement layers of layer encoded video images.

Layer encoding, such as Fine Granular Scalar (FGS), and wavelet encoding, are well-known in the video image encoding art. FGS encoding, for example, encodes video images into a base-layer and an enhancement layer. The base layer represents the minimum image that that may be transmitted over a network with an acceptable quality. The enhancement layer represents additional image details that may be transmitted over the network when sufficient residual bandwidth is available.

Enhancement layers are encoded in a bit-plane format wherein the most significant bits of each enhancement layer value are stored in a first bit plane and each succeeding bit of each enhancement layer value is stored in a corresponding bit plane. During transmission of the enhancement layer, the values in each bit plane are successively transmitted until the available bandwidth is occupied.

A concept of fractional bit planes has been introduced in JPEG-2000 to differentiate the importance of the various bits within a bit plane and improve the efficiency of bit plane coding within a bit plane. This concept does not exist in other layer encoding methods, such as FGS. Hence, there is a need for an encoding method and device wherein areas of the video image that are determined to be significant are identified prior to encoding the enhancement layer.

In the drawings:

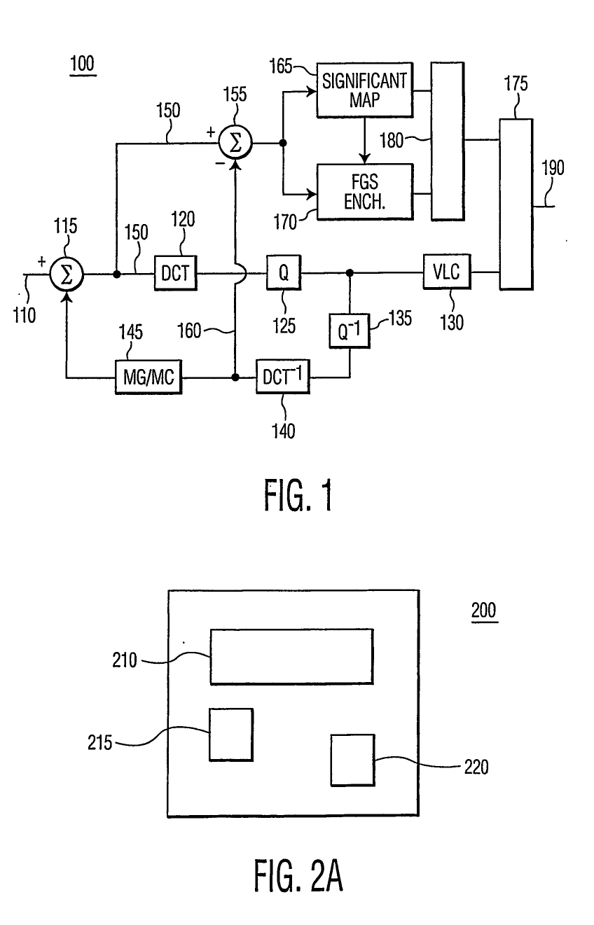

FIG. 1 illustrates an FGS fractional bit plane encoder in accordance with the principles of the present invention;

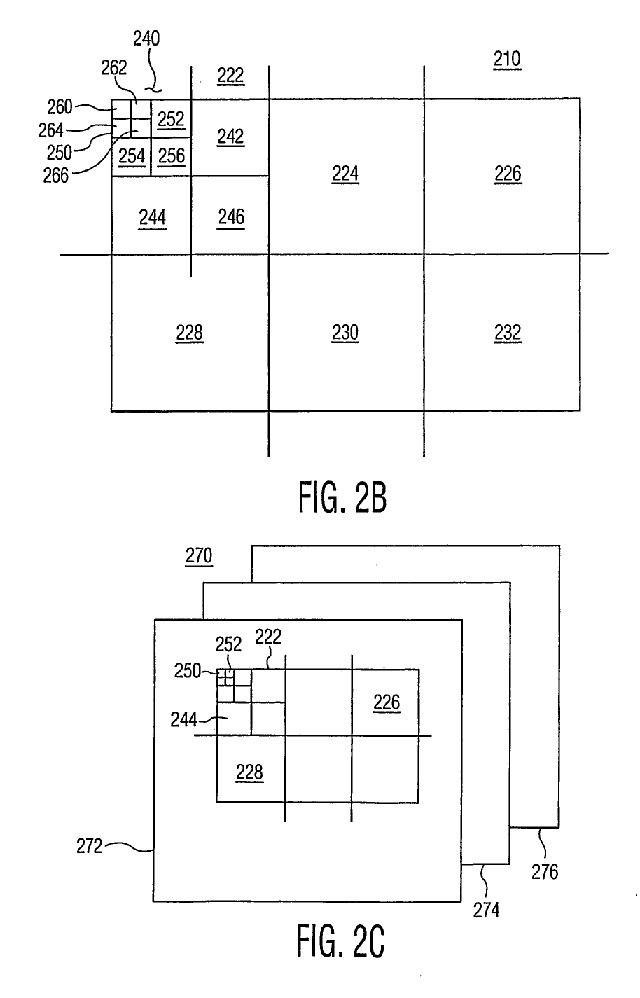

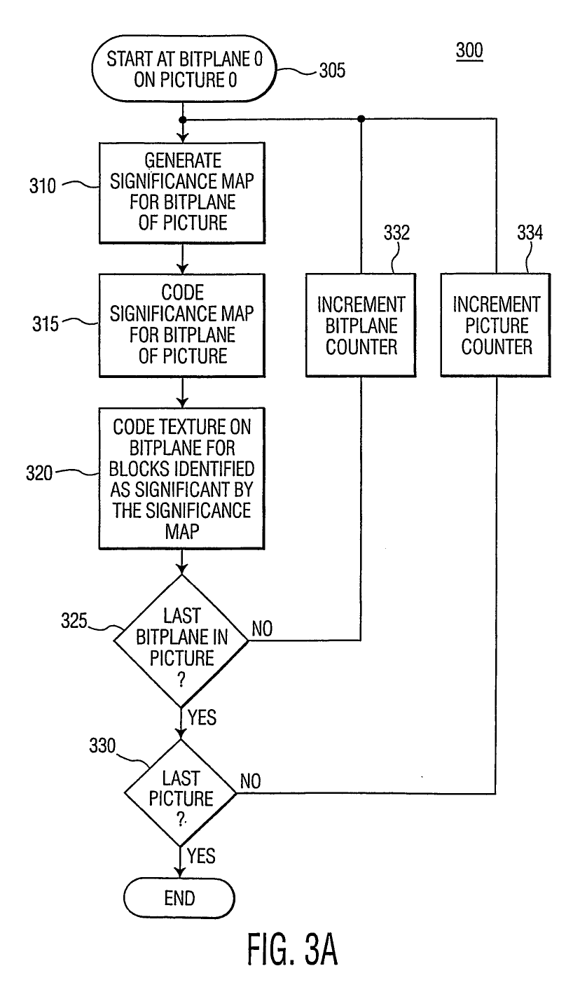

FIG. 2 illustrates a significance mapped enhancement layer bit plane; CONFIRMATION COPY

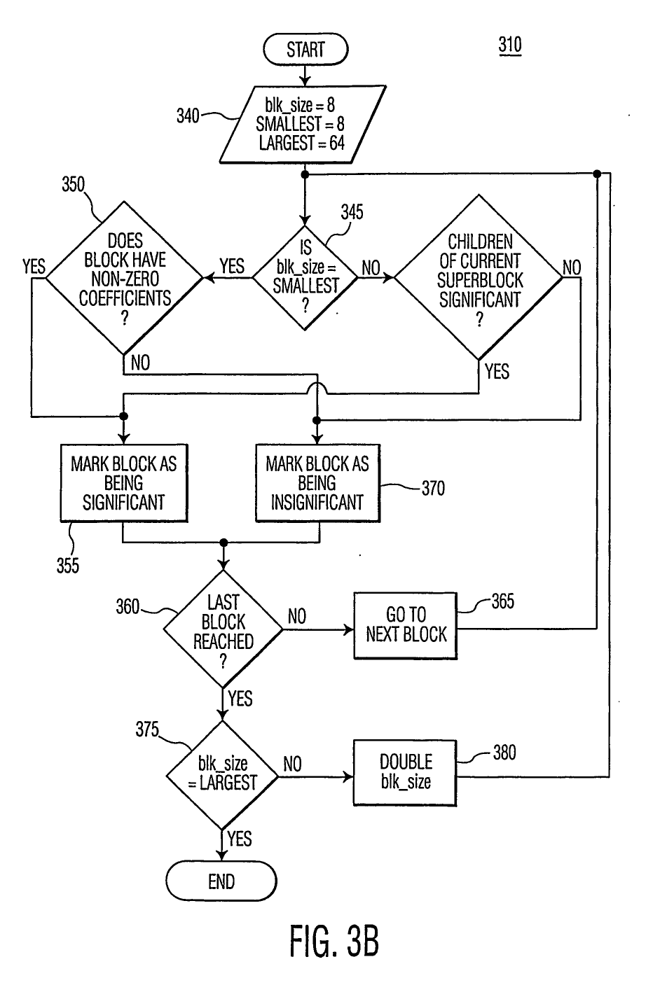

FIG. 3a illustrates a flow chart of an exemplary block diagram for identifying significant image areas within an image in accordance with the principles of the invention;

FIG. 3b illustrates a flow chart of an exemplary process for generating a significance map in accordance with the principles of the invention; and

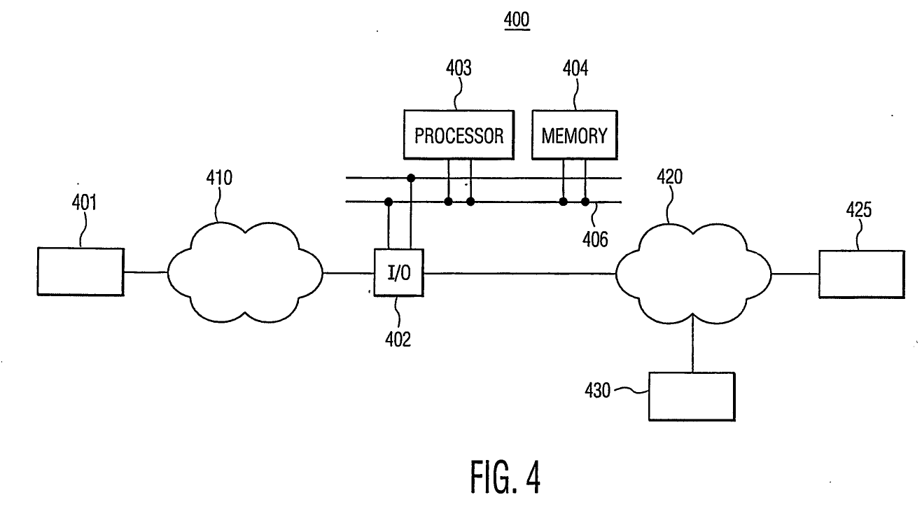

FIG. 4 illustrates a system for determining significance mapped enhancement layer bit planes in accordance with the principles of the invention.

It is to be understood that these drawings are solely for purposes of illustrating the concepts of the invention and are not intended as a definition of the limits of the invention. The embodiments shown in FIGS. 1 through 4 and described in the accompanying detailed description are to be used as illustrative embodiments and should not be construed as the only manner of practicing the invention. Also, the same reference numerals, possibly supplemented with reference characters where appropriate, have been used to identify similar elements.

In a layered encoding system having at least one layer comprising a plurality of sub-layers, a method is disclosed herein for encoding a video image composed of a plurality of pixel blocks containing at least one area determined to be significant within a corresponding sub-layer. The method comprises the steps of associating a level of significance with each block of a known size within the at least one significant area, associating a level of significance with each successively larger block dependent upon the level of significance of at least one of the blocks of a known size contained within a successively larger block, and mapping each of the associated level of significance.

In another embodiment of the invention, the significance map is transmitted and corresponding image layers may be reconstructed using the significance map.

FIG. 1 illustrates a block diagram of an exemplary fractional bit plane encoder 100 in accordance with the principles of the present invention. In this diagram, input signal 110 is applied to summer 115, which is mixed with motion compensated images, as will be further discussed. The combined signal is then applied to Discrete Coefficient Transformation (DCT) 120 to convert pixel values into coefficients. The DCT coefficients are next applied to quantizer 125 for quantization. The quantized DCT coefficients are then applied to a Variable Length Coder 130 and combiner 175.

The quantized DCT coefficients are also applied to inverse quantizer 135 to restore the DCT coefficients. As should be understood, the restored DCT coefficient are not exactly the same as the original DCT values as some information is lost in the quantization process. The inverse quantized coefficients are next applied to inverse DCT 140 to recover the original pixel element after DCT and quantization processing. Similarly, a known difference between the original pixel elements and the restored pixel elements exists because some information is lost in the quantization process. The recovered pixel elements are applied to motion estimator/motion compensator 145. The motion estimated/compensated signal is then applied to summing device 115 to be combined with the original image 110.

The summed image 150 is also applied to summing device 155 along with the recovered pixel elements output from inverse DCT 140. The output of summing device is a residual element between the original signal 110 and recovered base layer image. The residual image is concurrently applied to enhancement layer encoder 160 and significance map encoder 165. The results of significance map encoder 165 are further applied to enhancement encoder 170 for mapping the bit planes as will be more fully described.

The outputs of enhancement layer 170 and significance map 165 are applied to combiner 180 and the combined output applied to combiner 175. The output 190 of combiner 175 may then be transmitted over a network or stored for subsequent transmission.

FIG. 2a illustrates an image frame 200 containing significant information, such as changes in boundaries, color or texture. Significant images areas 210, 215, 220 may be identified using known methods. Correspondingly, areas that exhibit little or no change in textual may be identified as non-significant. Consequently, little or no information regarding these areas need be transmitted. Accordingly, in one embodiment of the invention, the determination of significant areas may be done by reviewing each pixel element. In a preferred embodiment, the determination of significant areas may be done by reviewing corresponding DCT coefficients.

FIG. 2b illustrates another aspect of the present invention, wherein a significant image area, for example 210, is associated with a plurality of blocks, corresponding macroblocks, and corresponding super-macroblocks. Although a specific segmentation of the image is shown, it will be appreciated that the image may be segmented according to other criteria; as will be discussed below. In this illustrated example, image area 210 is composed of super-macroblocks 222, 224, 226, 228, 230 and 232. Each super-macroblock may be partitioned into macroblocks. For clarity, super-macroblock 222 is shown partitioned into macroblocks 240, 242, 244 and 246. Each macroblock 240, 242, 244 and 246 may be further partitioned into a mini-macroblock. For clarity, macroblock 240 is shown partitioned into mini-macroblocks 250, 252, 254, and 256. Each mini-macroblock may be further partitioned into a block. For clarity purposes, mini-macroblock 250 is shown partitioned in to blocks 260, 262, 264 and 266. As will be appreciated, each super-macroblock may be similarly partitioned, identified and associated with macro-, mini-macro-, and blocks.

In a preferred embodiment, block 260 contains information associated with an 8×8 configuration of pixel elements. Furthermore, mini-macroblock 250 is associated with a 16×16 configuration of pixel elements, macroblock 240 is associated with a 32×32 configuration of pixel elements and super-macroblock 222 is associated with a 64×64 configuration of pixel elements. In this preferred embodiment, block 260 is analogous with the DCT encoding of a corresponding block of pixel elements.

FIG. 2c illustrates the bit-plane mapping 270 of the identified significant area 210 in bit planes 272, 274, and 276 in accordance with the preferred embodiment of the invention. In this case the enhancement layer is encoded using a three-bit-bitplane. However, it should be understood that the depth of the bit-planes may be any number and there is no intention to limit the bit-plane depth to that shown herein. In this preferred embodiment, since the DCT information is mapped to each bit-plane, area 210 and associated super-macroblocks, macroblocks, mini-macro blocks, and blocks may be readily identified.

FIG. 3a illustrates a flow chart of an exemplary process 300 for significance mapping in accordance with the principles of the invention. In this process significance mapping is initiated at an arbitrarily selected bit plane associated with the image or picture. In the illustrated preferred embodiment, the bit-plane associated with the most-significant bits, i.e, bit-plane 0, is selected at block 305. At block 310, a significance map associated with the selected bit plane is determined. At block 315, the significance map associated with the bit-plane is coded. At block 320, the texture of the blocks identified as being significant are coded and a bit-wise representation of the significance map is generated. This bit-wise representation of the significance map can be decoded at the receiving device to understand the significance map. At block 325, a determination is made whether all the bit planes associated with the image have been processed. If the answer is negative, then a next/subsequent bit plane is selected at block 332 and the significance mapping process continues for selected next/subsequent bit plane.

If, however, the answer is in the affirmative, then a determination is made at block 330 whether all the images have been processed. If the answer is negative, then a next/subsequent image or picture is selected at block 334. The significance mapping process then continues for each bit plane in the selected next/subsequent image or picture.

FIG. 3b illustrates a flow chart of an exemplary significance mapping process 310. In this exemplary process an initial block size and associated minimum and maximum block sizes are determined at block 340. In this case, an initial block size associated with the preferred block size is depicted. At block 345 a determination is made whether the current block size is equal to the smallest block size. If the answer is in the affirmative, a determination is made at block 350, whether the current block has any non-zero coefficients. If the answer is in the affirmative, then the associated block is marked or identified as being significant at block 355.

However, if the answer is negative, then the block is marked or identified as being insignificant at block 370.

After identifying the current block as significant, at block 355, or insignificant, at block 370, a determination is made at block 360 whether the last block has been reached. If the answer is negative, then a next/subsequent block in the bit plane is selected at block 365. Processing continues on the selected next/subsequent block at block 345.

If, however, the answer at block 360 is in the affirmative, i.e., all blocks at current-size have been processed, then a determination is made whether the current block-size is greater that the maximum block size. If the answer is in the negative, then the current block size is increased, preferably doubled, at block 380. Processing continues on each block associated with the increased size at block 345.

Returning to the determination at block 345, if the answer is negative, then a determination is made at block 385, whether smaller blocks, i.e., children within the larger block, are significant. If the answer is affirmative, then the larger block is marked or identified as being significant at block 355. If, however, the answer is in the negative, then the larger block is marked or identified as being insignificant at block 370.

Processing then continues on each of the successively larger block until the block size exceeds a maximum block size at block 375.

FIG. 4 illustrates an exemplary embodiment of a system 400 that may be used for implementing the principles of the present invention. System 400 may represent a TV transmitter or receiving system, a desktop, laptop or palmtop computer, a personal digital assistant (PDA), a video/image storage apparatus such as a video cassette recorder (VCR), a digital video recorder (DVR), a TiVO apparatus, etc., as well as portions or combinations of these and other devices. System 400 may contain one or more input/output devices 402, processors 403, and memories 404, which may access one or more sources 401 that contain video images. Sources 401 may be stored in permanent or semi-permanent media such as a television receiver (SDTV or HDTV), a VCR, RAM, ROM, hard disk drive, optical disk drive or other video image storage devices. Sources 401 may alternatively be accessed over one or more network connections 410 for receiving video from a server or servers over, for example a global computer communications network such as the Internet, a wide area network, a metropolitan area network, a local area network, a terrestrial broadcast system, a cable network, a satellite network, a wireless network, or a telephone network, as well as portions or combinations of these and other types of networks.

Input/output devices 402, processors 403, and memories 404 may communicate over a communication medium 406. Communication medium 406 may represent for example, a bus, a communication network, one or more internal connections of a circuit, circuit card or other apparatus, as well as portions and combinations of these and other communication media. Input data from the sources 401 is processed in accordance with one or more software programs that may be stored in memories 404 and executed by processors 403 in order to supply fractionally encoded video images to network 420. The fractionally encoded vided images may be transmitted to a storage device, or may be transmitted to a display system for real-time viewing of the encoded video image.

Processors 403 may be any means, such as general purpose or special purpose computing system, or may be a hardware configuration, such as a laptop computer, desktop computer, handheld computer, dedicated logic circuit, integrated circuit, Programmable Array Logic (PAL), Application Specific Integrated Circuit (ASIC), etc., that provides a known output in response to known inputs.

In a preferred embodiment, the coding and decoding employing the principles of the present invention may be implemented by computer readable code executed by processor 403. The code may be stored in the memory 404 or read/downloaded from a memory medium such as a CD-ROM or floppy disk (not shown). In other embodiments, hardware circuitry may be used in place of, or in combination with, software instructions to implement the invention. For example, the elements illustrated herein may also be implemented as discrete hardware elements.

In one aspect of the invention, the term processor may represent one or more processing units or computing units in communication with one or more memory units and other devices, e.g., peripherals, connected electronically to and communicating with the at least one processing unit. Futhermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

Fundamental novel features of the present invention have been shown, described, and pointed out as applied to preferred embodiments. It should be understood that various omissions and substitutions and changes in the apparatus described, in the form and details of the devices disclosed, and in their operation, may be made by those skilled in the art without departing from the spirit of the present invention. For example, although the present invention has been described with regard to FGS encoding, it should be understood that present invention would also be suitable for similarly developed layer encoding systems. Similarly, while super-macroblocks are discussed with regard to 64×64 arrays or matrices, it should be within the knowledge of those skilled in the art to vary the block size. Furthermore, while the boundaries of the super-macroblocks are shown fixed, it is contemplated that the super-macroblock boundaries may be dynamically determined based on the first indication of significant data.

It is also expressly intended that all combinations of those elements which perform substantially the same function in substantially the same way to achieve the same result are within the scope of the invention. Substitutions of elements from one described embodiment to another are also fully intended and contemplated.

1. In a layered encoding system having at least one layer comprising a plurality of sub-layers, a method for encoding a video image (200), composed of a plurality of pixel blocks, containing at least one area determined to be significant (210) within a corresponding sub-layer (272, 274, 276), said method comprising the steps of:
a. associating a level of significance with each block of a known size (250, 252) within said at least one significant area (210);
b. associating a level of significance with each of at least one successively larger blocks (222, 244) dependent upon said level of significance of at least one of said blocks (250, 252) of a known size contained within said successively larger block (222, 244); and
c. mapping each of said associated levels of significance.

2. The method as recited in claim 1, further comprising the step of:
repeating steps a-c for each of said sub-layers.

3. The method as recited in claim 1, further comprising the step of:
transmitting said significance level mapping corresponding to said sub-layer.

4. The method as recited in claim 1, wherein said layer encoding system is a Fine Granular Scalable (FGS) System.

5. The method as recited in claim 4, wherein said sub-layer is a bit-plane (272, 274, 276).

6. The method as recited in claim 1, wherein said block size is selected from a predetermined set of sizes.

7. The method as recited in claim 1, wherein said successively larger block has a known maximum value.

8. A system (400) for encoding (100) a video image (200) formed as a plurality of pixel blocks into at least one layer wherein one of said layers is composed of a plurality of sub-layers (272, 274, 276), said sub-layer including at least one significant area (210), comprising:
means (165) for associating a level of significance with each block of a known size (250, 252) within said at least one significant area (210);
means (165) for identifying a level of significance with each of at least one successively larger block (222, 244) dependent upon said level of significance of at least one of said blocks (250, 252) of a known size contained within said successively larger block (222, 244); and
means (165) for mapping said level of significance.

9. The system as recited in claim 8, wherein said mapping includes information regarding each of said blocks of known size and successive blocks having a known level.

10. The system as recited in claim 8, wherein said known level is representative of a non-zero coefficient.

11. A decoding system for decoding images transmitted as a layer encoded signal, comprising:
means for receiving data corresponding to a significance mapping of at least one sub-layer of said layered encoding signal;
means for decoding said significance map; and
means for reconstructing a corresponding one for said sub-layers from said significance map.

12. The decoding system as recited in claim 11, further comprising:
means for receiving said layer encoded signal transmitted over a network.

13. The decoding system as recited in claim 11, wherein said significance map includes information regarding blocks containing significant information.
